(19) United States
(12) Patent Application Publication
(10) Pub. No.: US 2026/0162534 A1
(43) Pub. Date: Jun. 11, 2026

(54) MANAGEMENT APPARATUS, MANAGEMENT METHOD, AND PROGRAM

(71) Applicant: NTT, Inc., Tokyo (JP)

(72) Inventors: Atsushi ISOMURA, Musashino-shi, Tokyo (JP); Nobuhiro OKI, Musashino-shi, Tokyo (JP); Ichibe NAITO, Musashino-shi, Tokyo (JP); Isoo UENO, Musashino-shi, Tokyo (JP); Naoko SHIGEMATSU, Musashino-shi, Tokyo (JP); Shmuel UR, Shorashim, Israel (IL); Vlad DABIJA, Huntington Beach, CA (US); David ASH, Pleasant Hill, CA (US)

(21) Appl. No.: 18/706,493

(22) PCT Filed: Mar. 29, 2022
(86) PCT No.: PCT/JP2022/015298

§ 371 Date: May 1, 2024

Related U.S. Application Data
(60) Provisional application No. 63/277,847, filed on Nov. 10, 2021.

(51) Int. Cl. G08G 1/16

(52) U.S. Cl. CPC G08G 1/16

(57) ABSTRACT

A management device 10 includes an area setting unit 12 that searches a spatio-temporal database 30 for information on objects on a road at a current time, sets an area having a predetermined size surrounding the object for each of the objects that have been found, and stores information on the area in the spatio-temporal database 30 in association with time information and position information of the object, a determination unit 13 that determines whether an inside of the area is safe based on a search result, and a path calculation unit 14 that calculates a movement path of the object based on the area. In a case where the inside of the area is not safe, the area setting unit 12 sets a new area for the object, and when there is an area of another object overlapping the new area, the area setting unit sets a new area for the other object.

### TECHNICAL FIELD

The present invention relates to a management device, a management method, and a program.

### BACKGROUND ART

In recent years, automated driving technology has been actively developed. When a vehicle encounters a danger while traveling, for example, when there is an obstacle on a road, the traveling line is changed or the speed is reduced in order to avoid the danger. The avoidance behavior may also affect other vehicles, and the flow of traffic may be disturbed or new vehicles may collide with each other. In Non Patent Literature 1 and 2, vehicle collision is avoided using vehicle-to-vehicle communication (V2V).

On the other hand, Patent Literature 1 and Non Patent Literature 3 propose a high-speed spatio-temporal data management technology that searches for a dynamic object in a certain space in real time at a certain time while accumulating information transmitted by a large number of dynamic objects in a real space.

### CITATION LIST

### Patent Literature

Patent Literature 1: JP 2020-13539 A

### Non Patent Literature

Non Patent Literature 1: Michael R. Hafner, et al., “Cooperative Collision Avoidance at Intersections: Algorithms and Experiments”, IEEE TRANSACTIONS ON INTELLIGENT TRANSPORTATION SYSTEMS, VOL. 14, NO. 3, SEPTEMBER 2013, pp. 1162-1175
Non Patent Literature 2: Ivan Pisa, et al., “VAIMA: a V2V based Intersection Traffic Management Algorithm”, 2018 14th Annual Conference on Wireless On-demand Network Systems and Services, 2018, pp. 125-128
Non Patent Literature 3: Masayuki Hanadate and 8 others, “Introduction to Axispot™, Real-time Spatio-temporal Data-management System, and Its High-speed Spatio-temporal Data-search Technology”, NTT Technical Journal, Nippon Telegraph and Telephone Corporation, November 2019, Vol. 31, No. 11, pp. 18-22

### SUMMARY OF INVENTION

### Technical Problem

A vehicle facing a danger such as a falling object can control itself to avoid the danger, but an avoidance behavior of avoiding a sudden danger affects another vehicle, which may in turn affect another vehicle. In the automated driving technology, it is desired to curb occurrence of a chain accident.

The present invention has been made in view of the above, and an object of the present invention is to curb occurrence of a chain accident in an automated vehicle traveling on a road on the ground.

### Solution to Problem

According to one aspect of the present invention, there is provided a management device including: an area setting unit configured to set an area having a predetermined size surrounding an object for the object and store the area in a spatio-temporal database in association with time information and position information of the object; a search unit configured to search the spatio-temporal database for information on an object around the object at a time indicated by the time information; and a determination unit configured to determine whether or not an inside of the area is safe on the basis of a search result, in which, in a case where the inside of the area is not safe, the area setting unit sets a new area for the object, and when there is an area of another object overlapping the new area, the area setting unit sets a new area for the other object.

According to one aspect of the present invention, there is provided a management method including: by a computer, setting an area having a predetermined size surrounding an object for the object and storing the area in a spatio-temporal database in association with time information and position information of the object; searching the spatio-temporal database for information on an object around the object at a time indicated by the time information; determining whether or not an inside of the area is safe on the basis of a search result; setting, in a case where the inside of the area is not safe, a new area for the object, and setting, when there is an area of another object overlapping the new area, a new area for the other object; and calculating a movement path of the object on the basis of the area.

### Advantageous Effects of Invention

According to the present invention, it is possible to curb occurrence of a chain accident in a plurality of moving objects including an automated vehicle.

### BRIEF DESCRIPTION OF DRAWINGS

FIG. 1 is a diagram illustrating an example of a configuration of a traffic management system including a management device according to the present embodiment.

FIG. 2 is a flowchart illustrating an example of an operation of the management device.

FIG. 3 is a diagram for describing setting of a new bubble.

FIG. 4 is a diagram illustrating an example of a configuration of another traffic management system according to the present embodiment.

FIG. 5 is a flowchart illustrating an example of an operation of a vehicle of FIG. 4.

FIG. 6 is a diagram illustrating an example of a hardware configuration of a management device.

### DESCRIPTION OF EMBODIMENTS

Hereinafter, an embodiment of the present invention will be described with reference to the drawings.

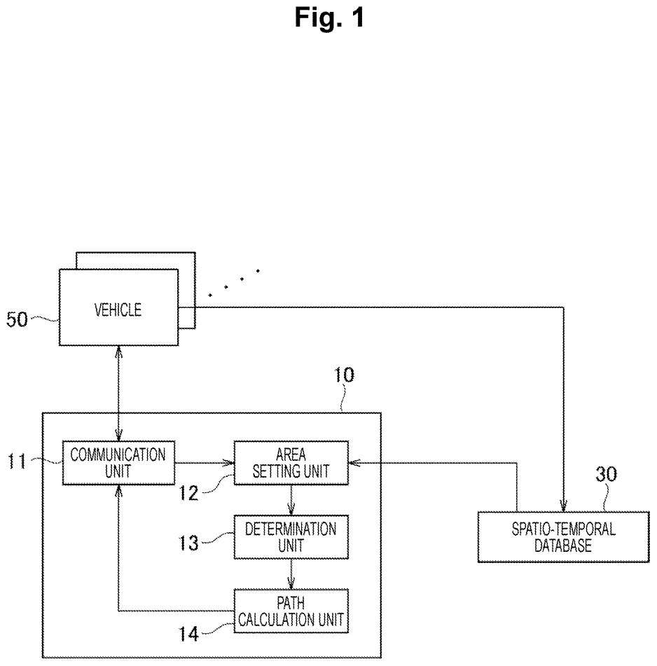

FIG. 1 is a diagram illustrating an example of a configuration of a traffic management system including a management device 10 according to the present embodiment. The system in FIG. 1 is a device that includes the management device 10 and a spatio-temporal database 30 and manages a travel path of a vehicle 50 that is automatically driven or semi-automatically driven.

The management device 10 sets a three-dimensional area (hereinafter referred to as an “area”) having a predetermined size necessary for an object (for example, an automobile, a person, or the like) present on the road to safely avoid the object. Upon detecting an obstacle or another object in the area, the management device 10 sets a new area in the object and calculates a path of the object such that the object enters the new area. In a case where the new area overlaps the area of another object, a new area is recursively calculated for the other object.

The spatio-temporal database 30 is a database that accumulates and searches for a data group associated with both time information and spatial information at high speed. As the spatio-temporal database 30, those described in Patent Literature 1 and Non Patent Literature 3 can be used. For example, the spatio-temporal database 30 performs data storage and data search using a spatio-temporal code generated by extending a spatial code in which spatial information is made one-dimensional to a time domain as a key of a distributed key variable store (KVS). Assuming that the maximum value of time is 64 years, the maximum value of latitude is one round of the earth, and the maximum value of longitude is a semicircle of the earth, when the spatio-temporal code is composed of 36 bits of time, 30 bits of latitude, and 30 bits of longitude, it is possible to express a rectangle of at least 30 ms×3 cm×3 cm square. By changing the length of the spatio-temporal code provided as a search condition, the range of time and space at which it is desired to search can be changed.

The vehicle 50 generates a spatio-temporal code using the current time and the current position of the vehicle 50, and stores information regarding the vehicle 50 in the spatio-temporal database 30 using the generated spatio-temporal code as a key. The vehicle 50 may store information in the spatio-temporal database 30 using a spatio-temporal code generated using a future time and a planned future position of the vehicle 50 as a key on the basis of a planned traveling path. The vehicle 50 may store information in the spatio-temporal database 30 via the management device 10.

In the case of a pedestrian, a smartphone held by the pedestrian may store information regarding the pedestrian in the spatio-temporal database 30 in association with time information and position information of the pedestrian. The future position of the pedestrian may be stored in the spatio-temporal database 30. The smartphone may store information in the spatio-temporal database 30 via the management device 10.

A sensor installed beside a road may detect an object on the road, and store information regarding the object in the spatio-temporal database 30 in association with time information and position information of the object. The future position of the object may be stored in the spatio-temporal database 30. The sensor may store information in the spatio-temporal database 30 via the management device 10.

The management device 10 in FIG. 1 includes a communication unit 11, an area setting unit 12, a determination unit 13, and a path calculation unit 14.

The communication unit 11 communicates with the vehicle 50, receives information regarding the vehicle 50 from the vehicle 50, and transmits travel path information to the vehicle 50. The information regarding the vehicle 50 includes, for example, a current position, a traveling direction, a traveling speed, a planned traveling path, a type, and the like of the vehicle 50. The travel path information is information indicating a path on which the vehicle 50 to be automatically driven or semi-automatically driven should travel. The communication unit 11 may communicate with a device other than the vehicle 50.

The area setting unit 12 searches the spatio-temporal database 30 for information on objects on the road at the current time, and sets an area for each of the objects that have been found. This area is a three-dimensional area in which the object can safely perform avoidance behavior. That is, when the object moves, the area is a three-dimensional area in which the object can take behaviors for avoiding a dangerous state by itself by changing, controlling, and braking its own moving speed and traveling direction. The areas can be of various sizes and shapes depending on traffic conditions. For example, the area setting unit 12 sets a large area for an object having a fast moving speed, sets a small area for an object having high controllability, or sets a large area when the road surface is frozen. Hereinafter, an example of information used when the area setting unit 12 sets an area will be described.

When the area setting unit 12 sets the area, information obtained from the inside of the object may be used. For example, information from control devices used for movement and operation control of an object, various sensor information such as a GPS and an in-vehicle camera, and video information can be used. Information such as specifications and setting values based on the movement performance of the object may be used. In a case where the object is an automobile, in addition to the weight of the load, the braking status when the brake is applied may be ascertained, and information on the slipperiness of the road surface or the like may be used. Information from a sensor or the like that can be collected inside the object can be used without the object depending on an external network.

When the area setting unit 12 sets the area, information obtained from the outside of the object may be used. For example, information regarding an external environment such as a traffic condition, a degree of congestion, weather, and a road surface condition around an object can also be utilized. A distance to another surrounding object, a moving direction of the surrounding object, a moving speed, and the like may be used. The information outside the object can be acquired via an external network such as a cloud.

When the area setting unit 12 sets the area, GPS information of a smartphone of a passenger on the object or the like can also be used although not directly connected to the object. In this case, the object may directly communicate with a device owned by a person, or the information may be acquired via an external network such as a cloud.

In a case where the area is set using the information obtained from the inside of the object, the object may send the information obtained from the inside of the object to the management device 10 or may store the information in the spatio-temporal database 30. The area setting unit 12 acquires information obtained from the inside of the object and sets an area where safety avoidance is possible for the object. The area setting unit 12 may set an area by integrating information obtained from the inside of the object and information obtained from the outside of the object. Alternatively, the object may include the area setting unit 12, the object itself may set an area using information obtained from the inside, and the set area may be stored in the spatio-temporal database 30, or may be sent to the management device 10.

The area setting unit 12 stores information on the area in the spatio-temporal database 30 in association with the time information and the position information of the object. Specifically, a spatio-temporal code is generated using time information and position information of the object, and information on an area in which the generated spatio-temporal code is set as a key in the object is stored in the spatio-temporal database 30.

The determination unit 13 determines whether or not the inside of the area is safe on the basis of a search result of the spatio-temporal database 30. Specifically, the determination unit 13 determines whether or not there is an object in the area, and whether the area is in contact with or overlaps an area of another object. In a case where the areas are in contact or overlap, the determination unit 13 determines that the inside of the area is not safe. Note that the determination unit 13 may distinguish the correspondence between the case where the areas are in contact and the case where the areas overlap.

In a case where the inside of the area is not safe, the area setting unit 12 sets a new area for avoiding danger, and stores information on the new area in the spatio-temporal database 30 in association with the time information and the object. The new area is set according to the previous movement of the object and traffic conditions. The area setting unit 12 may set the area on the basis of a planned position of the object at the future time of several tens of milliseconds to several hundreds of milliseconds. For example, the area setting unit 12 sets a new area at a position where danger can be avoided with reference to a planned position of the object after several tens of milliseconds to several hundreds of milliseconds.

When setting a new area, in a case where there is an area of another object overlapping the new area, the area setting unit 12 sets a new area in which the areas do not overlap.

The path calculation unit 14 obtains a travel path of the vehicle 50 such that the vehicle 50 is present in the new area, and transmits the obtained travel path to the vehicle 50.

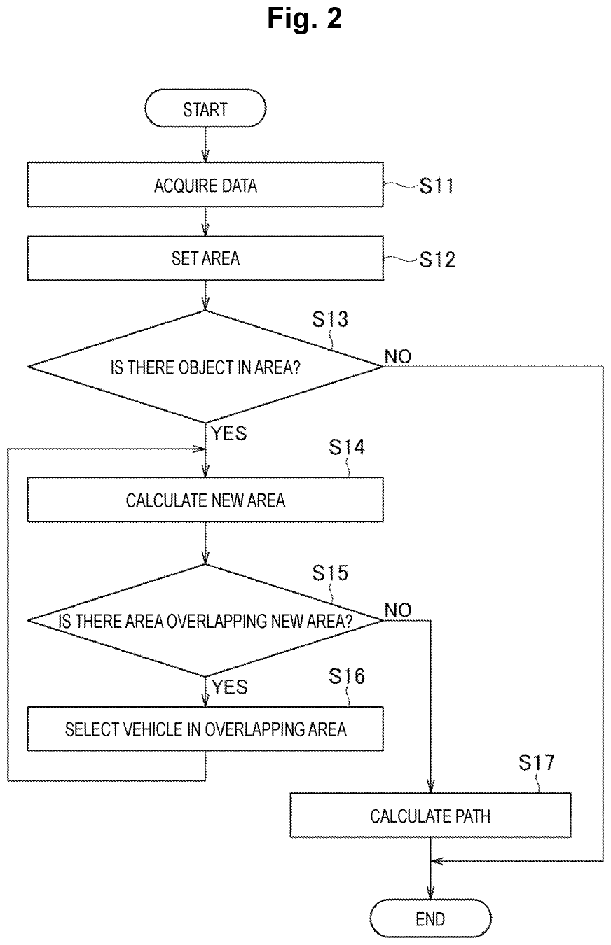

Next, an example of the operation of the management device 10 will be described with reference to the flowchart of FIG. 2. The processing of FIG. 2 is continuously and repeatedly performed.

In step S11, the management device 10 searches the spatio-temporal database 30 for information on the object on the road at the current time.

In step S12, the management device 10 sets an area for each of the objects that have been found. The management device 10 stores information on the area in the spatio-temporal database 30 in association with the time information and the position information of the object. Note that the processing in and after step S13 may be executed only for an object that can travel according to a new area. For example, the processing may be executed only for the vehicle 50 for which the management device 10 can provide an instruction of the travel path.

In step S13, the management device 10 determines for each area whether or not there is an object in the area.

In a case where there is no object in the area, in step S14, the management device 10 calculates a new area for the vehicle 50 in which the object is present in the area.

In step S15, the management device 10 determines whether or not there is an area of another object overlapping the new area. For example, the management device 10 makes a determination using the new area set in step S14 and the area of each object set in step S12. The management device 10 may generate a spatio-temporal code using the time information and the position information of the new area and search the spatio-temporal database 30 for an area of another object.

In a case where there is an area overlapping the new area, the management device 10 selects a vehicle in the overlapping area in step S16, and calculates a new area for the selected vehicle in step S14.

Thereafter, the processing from step S14 to step S16 is recursively repeated until there is no area overlapping the new area.

When there is no longer any area overlapping the new area, in step S17, the management device 10 calculates a travel path according to the new area for each vehicle for which the new area has been set, and notifies each vehicle of the calculated travel path. For example, the management device 10 obtains a travel path passing through the center of the new area.

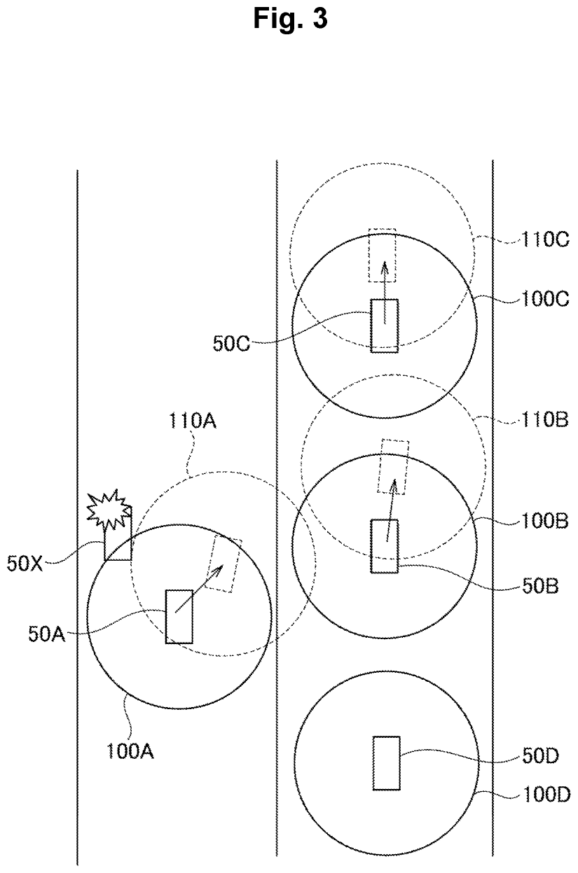

Next, setting of a new area will be described with reference to FIG. 3.

In FIG. 3, vehicles 50A to 50D travel upward in the drawing, and a failed vehicle 50X is stopped in the travel lane of the vehicle 50A. In FIG. 3, areas 100A to 100D of the vehicles 50A to 50D are illustrated. Although the areas 100A to 100D are indicated by circles, the present invention is not limited thereto. The areas 100A to 100D may be represented by polygons connecting a plurality of points.

Since the failed vehicle 50X is present in the area 100A of the vehicle 50A, a new area 110A is set for the vehicle 50A.

Since the new area 110A overlaps the area 100B of the vehicle 50B, a new area 110B is set for the vehicle 50B.

Since the new area 110B overlaps the area 100C of the vehicle 50C, a new area 110C is set for the vehicle 50C.

Since the area 100D of the vehicle 50D does not overlap the new areas 110A to 110C, no new area is set for the vehicle 50D.

As illustrated in FIG. 3, when the vehicle 50A avoids the failed vehicle 50X, the new areas 100B and 100C are set such that the areas 110B and 110C of the other vehicles 50B and 50C do not overlap each other, and thus it is possible to curb a chain accident due to the avoidance behavior.

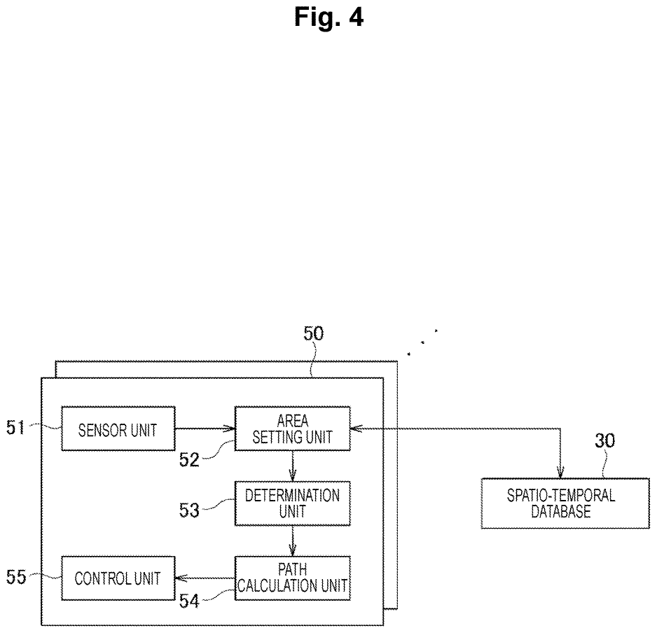

Next, an example in which a vehicle 50 has the function of the management device 10 will be described with reference to FIG. 4.

The vehicle 50 illustrated in FIG. 4 includes a sensor unit 51, an area setting unit 52, a determination unit 53, a path calculation unit 54, and a control unit 55.

The sensor unit 51 acquires sensing data from various sensors mounted on the vehicle 50, estimates the position and state of the vehicle 50 itself, and transmits the estimated position and state to the area setting unit 52.

The area setting unit 52 sets the area of the vehicle 50 itself from the position and state of the vehicle 50 and the like, and stores the information on the vehicle 50 and the area in the spatio-temporal database 30.

The area setting unit 52 searches the spatio-temporal database 30 for information on objects around the vehicle 50 and acquires the information. In a case where information on areas of other objects is stored, the information on the areas is also acquired.

The determination unit 53 determines whether or not the inside of the area is safe on the basis of a search result of the spatio-temporal database 30.

In a case where the inside of the area is not safe or the area overlaps the area of another object, the area setting unit 52 sets a new area and stores information on the new area in the spatio-temporal database 30.

The path calculation unit 54 obtains a travel path of the vehicle 50 such that the vehicle 50 is present in the new area.

The control unit 55 controls the vehicle 50 such that the vehicle travels according to the travel path obtained by the path calculation unit 54.

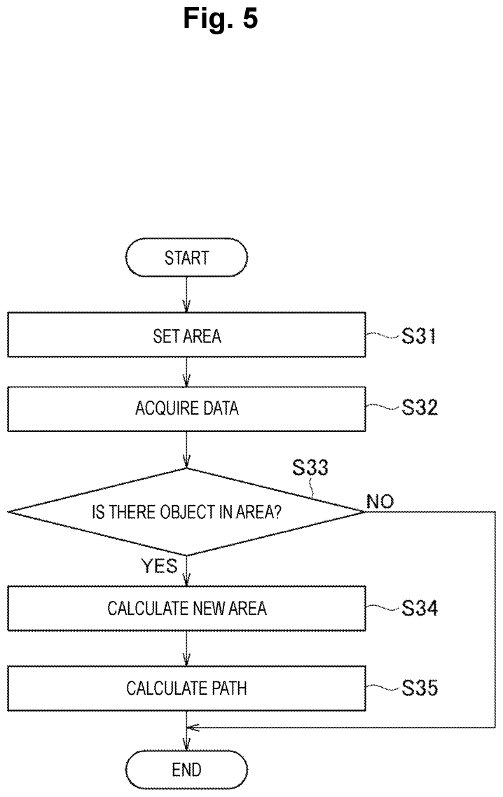

Next, an example of the operation of the vehicle 50 will be described with reference to the flowchart of FIG. 5.

In step S31, the area setting unit 52 sets an area for the vehicle 50 from the position and the state of the vehicle 50 estimated by the sensor unit 51, and stores information on the area in the spatio-temporal database 30 in association with the time information and the position information of the vehicle 50.

In step S32, the area setting unit 52 searches the spatio-temporal database 30 for information on objects around the vehicle 50.

In step S33, the determination unit 53 determines whether there is an object in the area or whether the area overlaps the area of another object.

In a case where there is an object in the area or the area overlaps the area of another object, the area setting unit 52 calculates a new area for the vehicle 50 in step S34.

In step S35, the path calculation unit 54 calculates the travel path of the vehicle 50 according to the new area, and the control unit 55 controls the vehicle 50 such that the vehicle travels according to the travel path obtained by the vehicle 50.

Since the new area for the vehicle 50 is stored in the spatio-temporal database 30, another vehicle around the vehicle 50 can acquire information on the new area from the spatio-temporal database 30, and in a case where the new area and its own area overlap, the new area can be calculated and stored in the spatio-temporal database 30. Even in a case where the vehicle 50 has the function of the management device 10, a new area is recursively calculated.

In a case where the new area set for the vehicle 50 overlaps the area of another object, the vehicle 50 may notify the other object of the overlapping by vehicle-to-vehicle communication.

As described above, the management device 10 according to the present embodiment includes the area setting unit 12 that searches the spatio-temporal database 30 for information on objects on a road at a current time, sets an area surrounding the object for each of the objects that have been found, and stores information on the area in the spatio-temporal database 30 in association with time information and position information of the object, the determination unit 13 that determines whether or not the inside of the area is safe on the basis of a search result, and the path calculation unit 14 that calculates a movement path of the object on the basis of the area. In a case where the inside of the area is not safe, the area setting unit 12 sets a new area for the object, and when there is an area of another object overlapping the new area, the area setting unit sets a new area for the other object. Accordingly, the influence of the sudden avoidance behavior on the surrounding vehicles can be curbed, and the occurrence of a chain accident can be curbed.

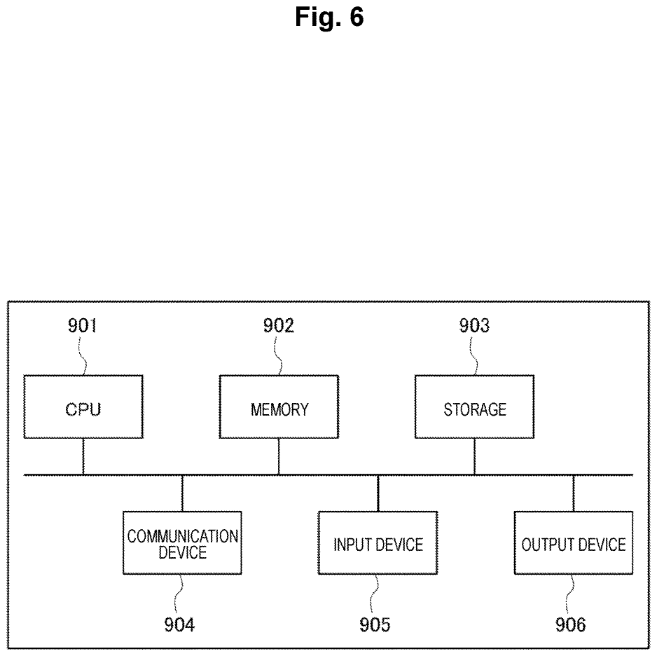

For example, as illustrated in FIG. 6, a general-purpose computer system including a central processing unit (CPU) 901, a memory 902, a storage 903, a communication device 904, an input device 905, and an output device 906 can be used as the management device 10 described above. In this computer system, the CPU 901 executes a predetermined program loaded on the memory 902, thereby implementing the management device 10. This program can be recorded on a computer-readable recording medium such as a magnetic disk, an optical disc, or a semiconductor memory, or can be distributed via a network. This program may be installed in the vehicle 50 via a network, and the vehicle 50 may have the functions of the management device 10.

Regarding the above embodiments, the following supplementary notes are further disclosed.

### (Supplementary Note 1)

A management device including:
a memory; and at least one processor connected to the memory,
in which the processor is configured to:
set an area having a predetermined size surrounding an object for the object and store the area in a spatio-temporal database in association with time information and position information of the object;
search the spatio-temporal database for information on an object around the object at a time indicated by the time information;
determine whether or not an inside of the area is safe on the basis of a search result;
calculate a movement path of the object on the basis of the area; and
set, in a case where the inside of the area is not safe, a new area for the object, and set, when there is an area of another object overlapping the new area, a new area for the other object.

### (Supplementary Note 2)

A non-transitory storage medium storing a program executable by a computer to execute management processing, the management processing including:
setting an area having a predetermined size surrounding an object for the object and storing the area in a spatio-temporal database in association with time information and position information of the object;
searching the spatio-temporal database for information on an object around the object at a time indicated by the time information;
determining whether or not an inside of the area is safe on the basis of a search result;
setting, in a case where the inside of the area is not safe, a new area for the object, and setting, when there is an area of another object overlapping the new area, a new area for the other object; and
calculating a movement path of the object on the basis of the area.

### REFERENCE SIGNS LIST

10 Management device
11 Communication unit
12 Area setting unit
13 Determination unit
14 Path calculation unit
30 Spatio-temporal database
50 Vehicle
51 Sensor unit
52 Area setting unit
53 Determination unit
54 Path calculation unit
55 Control unit

1. A management device comprising:
an area setting unit, including one or more processors, configured to set an area having a predetermined size surrounding an object for the object and store the area in a spatio-temporal database in association with time information and position information of the object;
a search unit, including one or more processors, configured to search the spatio-temporal database for information on an object around the object at a time indicated by the time information;
a determination unit, including one or more processors, configured to determine whether or not an inside of the area is safe on the basis of a search result; and
a path calculation unit, including one or more processors, configured to calculate a movement path of the object on the basis of the area,
wherein, in a case where the inside of the area is not safe, the area setting unit is configured to set a new area for the object, and when there is an area of another object overlapping the new area, the area setting unit sets a new area for the other object.

2. The management device according to claim 1, wherein the area is a three-dimensional area in which the object is able to safely perform avoidance behavior.

3. The management device according to claim 1, wherein the search unit is configured to generate a spatio-temporal code using time information indicating a time at which it is desired to search and spatial information indicating a space at which it is desired to search, and search the spatio-temporal database using the generated spatio-temporal code as a key.

4. A management method comprising:
by a computer,
setting an area in which an object is able to safely perform avoidance and storing the area in a spatio-temporal database in association with time information and position information of the object;
searching the spatio-temporal database for information on an object around the object at a time indicated by the time information;
determining whether or not an inside of the area is safe on the basis of a search result;
setting, in a case where the inside of the area is not safe, a new area for the object, and setting, when there is an area of another object overlapping the new area, a new area for the other object; and
calculating a movement path of the object on the basis of the area.

5. The management method according to claim 4, wherein the area is a three-dimensional area in which the object is able to safely perform avoidance behavior.

6. The management method according to claim 4, further comprising:
by the computer,
generating a spatio-temporal code using time information indicating a time at which it is desired to search and spatial information indicating a space at which it is desired to search, and searching the spatio-temporal database using the generated spatio-temporal code as a key.

7. A non-transitory computer-readable storage medium storing program causing a computer perform operations of a management method, the operations comprising:
setting an area in which an object is able to safely perform avoidance and storing the area in a spatio-temporal database in association with time information and position information of the object;
searching the spatio-temporal database for information on an object around the object at a time indicated by the time information;
determining whether or not an inside of the area is safe on the basis of a search result;
setting, in a case where the inside of the area is not safe, a new area for the object, and setting, when there is an area of another object overlapping the new area, a new area for the other object; and
calculating a movement path of the object on the basis of the area.

8. (canceled)

9. The non-transitory computer-readable storage medium according to claim 7, wherein the area is a three-dimensional area in which the object is able to safely perform avoidance behavior.

10. The non-transitory computer-readable storage medium according to claim 7, wherein the operations further comprise:
generating a spatio-temporal code using time information indicating a time at which it is desired to search and spatial information indicating a space at which it is desired to search, and searching the spatio-temporal database using the generated spatio-temporal code as a key.
